(19) United States
(12) Patent Application Publication
(10) Pub. No.: US 2013/0100505 A1
(43) Pub. Date: Apr. 25, 2013

(54) DOCUMENT SCANNER FOR A HANDHELD COMPUTING DEVICE

(71) Applicant: inMusic Brands, Inc., Cumberland, RI (US)

(72) Inventors: Brian R. Shim, Providence, RI (US); Wendy L. Mittlestadt, Lowell, MA (US)

(73) Assignee: INMUSIC BRANDS, INC., Cumberland, RI (US)

(21) Appl. No.: 13/651,430

(22) Filed: Oct. 14, 2012

Related U.S. Application Data
(60) Provisional application No. 61/551,236, filed on Oct. 25, 2011.

(51) Int. Cl. H04N 1/04

(52) U.S. Cl. CPC H04N 1/04
USPC 358/474

(57) ABSTRACT

A scanner for a handheld computing device is disclosed. The scanner includes a housing. A USB port is on the housing. The scanner also includes a memory. A scanning microprocessor is configured and arranged to scan and store images on the memory. An USB controller is configured and arranged to mount the memory as a USB mass storage class device to a handheld computing device connected to the USB port.

### CROSS-REFERENCE TO RELATED APPLICATION

This patent document claims priority to earlier filed U.S. Provisional Patent Application Ser. No. 61/551,236, filed on Oct. 25, 2012, the entire contents of which are incorporated herein by reference.

### BACKGROUND

1. Technical Field

The present patent document relates generally to document scanning and more particularly to a document scanner for handheld computing devices, such as tablet computers and smartphones.

2. Background of the Related Art

There currently exist portable scanners with removable secure digital (“SD”) cards and/or universal serial bus (“USB”) connectivity. Some examples include the ION Audio, LLC Copy Cat™ and Docuscan™ scanner product. These are battery-powered handheld devices that scan to SD card.

However, these types of scanners require special dongles or connectivity kits to work with handheld computing devices that lack built-in SD card slots and/or USB serial ports. For instance, the very popular Apple, Inc. iPad® brand tablet computer does not have an SD card slot or a built-in USB port. Consequently, transferring photos into the iPad® requires the Apple Camera Connection Kit, which is a separate connector that turns the iPad®'s SO-pin connector into an SD card slot or USB connector. This is cumbersome and requires purchase of the Camera Connection Kit.

The other method to get scanned images into the iPad® is to load the scanned images into a computer first, then sync that computer with the iPad®.

This is cumbersome and time-consuming, and requires a computer. Other handheld computing devices have a similar limitation.

Therefore, there is a perceived need in the industry for a method of transferring scanned documents and photos to a handheld computing device that lack USB ports and SD card slots and that does not require synchronizing with a computer or special dongles.

### SUMMARY

The present invention solves the problems of the prior art by providing a document scanner for a handheld computing device that is portable, battery powered and convenient. Specifically, the document scanner includes and scanner and a means of connecting the scanner to a handheld computing device serial data interface to permit transfer of images to the handheld computing device.

### BRIEF DESCRIPTION OF THE DRAWINGS

These and other features, aspects, and advantages of the present invention will become better understood with reference to the following description, appended claims, and accompanying drawings where:

FIG. 1 shows a schematic diagram of a first embodiment of the document scanner for a handheld computing device of the present invention.

FIG. 2 shows a schematic diagram of a second embodiment of the document scanner for a handheld computing device of the present invention.

FIG. 3 shows a schematic diagram of a third embodiment of the document scanner for a handheld computing device of the present invention.

FIG. 4 shows a top view of an embodiment of a document scanner for a handheld computing device.

FIG. 5 shows an embodiment of a document scanner for a handheld computing device.

### DESCRIPTION OF THE PREFERRED EMBODIMENT

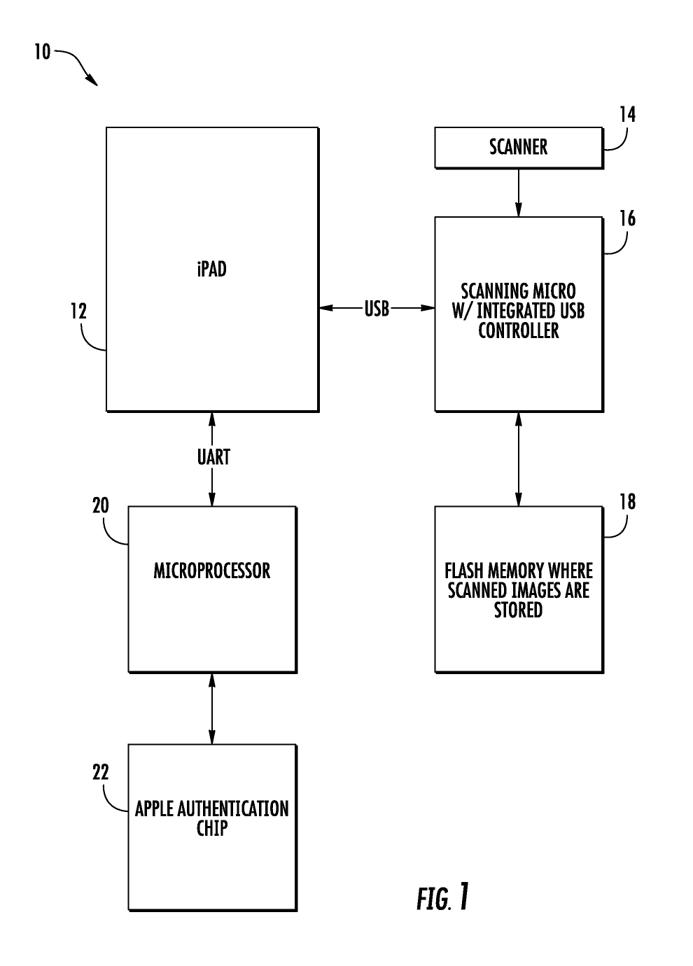

Referring now to FIG. 1, a schematic diagram of a first embodiment of the document scanner for a handheld computing device 12 is shown generally at 10. The first embodiment 10 includes a scanner 14 that includes a scanning microprocessor 16 and a flash memory 18. The scanning microprocessor 16 is configured to operate the scanner 14 and store scanned images on the flash memory 18. The flash memory 18 is configured to be accessible as a USB Mass Storage Class Device via a USB controller, which may be integrated with the scanning microprocessor 14. The flash memory 18 can be removable (e.g. an SD card) or permanently connected (e.g. soldered).

The handheld computing device 12, such as an iPad® brand tablet computer, is connected to the document scanner, before, during or after scanning of the documents or photographs at the user's convenience. After the images are scanned, the scanner is connected to the handheld computing device's serial data interface. For instance, iPad®'s 30-pin connector and 9-pin digital Lightning™ connector. Images may then be transferred to the handheld computing device's 12 memory.

The document scanner 10 includes a second microprocessor 20 and an authentication chip 22. The second microprocessor 20 communicates with the handheld computing device 12 via a slow-speed universal asynchronous receiver/ transmitter (“UART”) connection (e.g. pins 18 and 19 within the iPad®'s 30-pin connector) and with the authentication chip to enable USB mass storage class communication between the handheld computing device 12 and the document scanner 10. It is important to note that this method would not be used with Apple's 9-pin digital Lightning™ connector because the USB implementation described in the second embodiment would be preferable. The document scanner's 10 USB signals are connected to USB pins on the handheld computing device 12 serial data interface (e.g. pins 4 and 6 of the iPad®'s 30-pin connector).

After the authentication process completes, the handheld computing device 12 connects to the document scanner 10 as a mass-storage class device. The handheld computing device 12 is then able to read and copy scanned images from the document scanner's 10 flash memory 18 and into the handheld computing device's 12 memory and manipulated with a photo application running thereon.

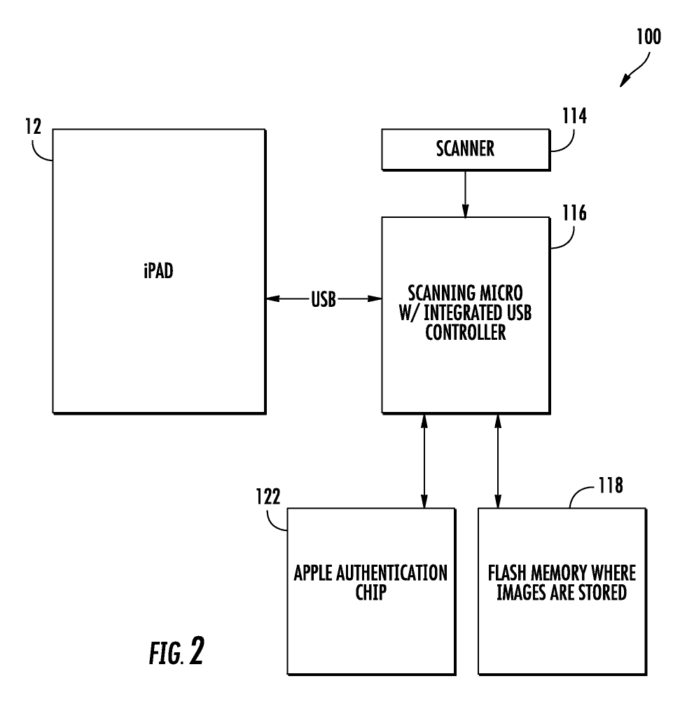

Referring now to FIG. 2, a schematic diagram of a second embodiment of the document scanner for a handheld computing device 12 is shown generally at 100. In the second embodiment 100, authentication is performed through the handheld computing device's 12 serial data interface, specifically the USB port, by the scanning microprocessor 116, which also operates the scanner 114. Thus no separate microprocessor 20 is required for authentication as compared to the first embodiment 10. From the user's point of view, the scanning process is the same as in the first embodiment 10. The difference in implementation is that the authentication process is now performed by the same microprocessor that does the scanning 116, and it is done through the handheld computing device's 12 USB port instead of the UART port.

Like the first embodiment 10, the second embodiment 100 includes a flash memory 118 that is configured to be accessible as a USB Mass Storage Class Device. The flash memory 118 can be removable (e.g. an SD card) or permanently connected (e.g. soldered). An authentication chip 122 may be required to enable USB functionality on the handheld computing device 12.

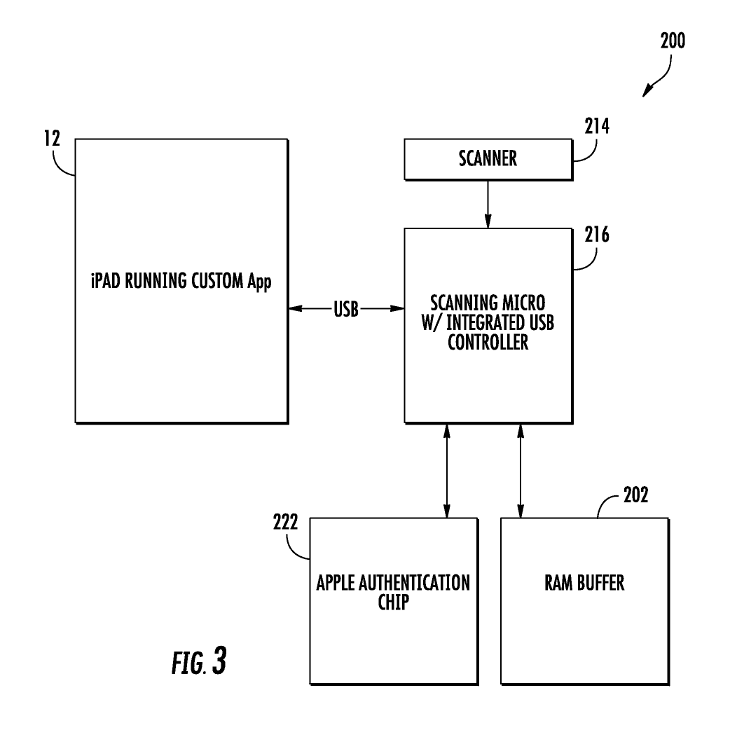

Referring now to FIG. 3, a schematic diagram of a third embodiment of the document scanner for a handheld computing device 12 is shown generally at 200. The third embodiment 200 is fundamentally different from the other two, in that the image is not stored on a flash memory before being sent to the handheld computing device 12. Instead, the image is sent directly to the handheld computing device 12 in real-time without being stored in non-volatile storage on the scanner itself. The image is stored temporarily in buffer random access memory (“RAM”) 20 prior to being transferred to the handheld computing device 12.

In the third embodiment, the document scanner 200 must be connected to the handheld computing device 12 during scanning of an image.

The microprocessor 116 in the document scanner 200 communicates with the handheld computing device 12 and the authentication chip 222 to enable USB communications with the handheld computing device 12 using a proprietary protocol, such as the External Accessory Framework protocol (instead of USB mass-storage device protocol). The proprietary protocol requires a software application to be running on the handheld computing device 12 that is configured to communicate via the proprietary protocol.

When the user starts to scan, the image is not stored in a flash memory, but is instead sent to the handheld computing device 12. Part of the image may be buffered in RAM 202 during this transmission process. The software application running on the handheld computing device 12 will receive the transmission of the image encoded n the proprietary protocol. The format of the image may be raw bit-mapped pixels, or the image may be in a compressed format such as JPEG or other image format, such as tiff, gif, etc.

The software application then stores the image to the handheld computing device's 12 memory, where it may be accessed and further manipulated by other software applications.

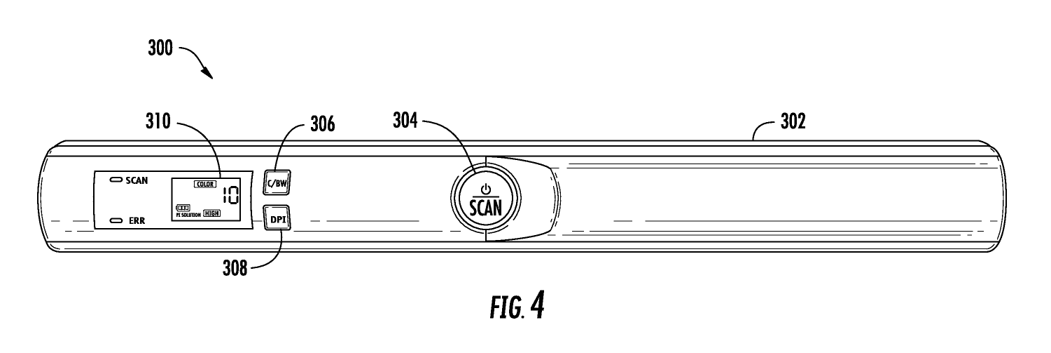

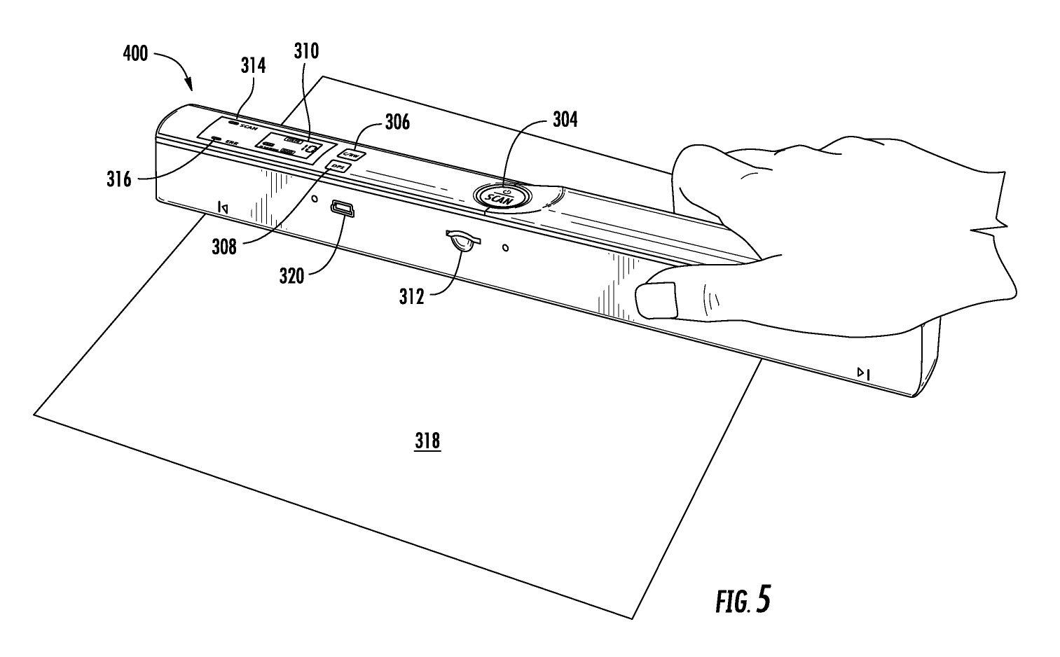

Referring to FIGS. 4 and 5, an embodiment of a scanner for a handheld computing device 12 is shown generally at 300. The scanner 300 includes a wand-shaped housing 302 with a scanning element on the bottom. The scanner 302 includes a Scan/Power button 304 to activate the scanner 300 and enable scanning to the flash memory or RAM (depending upon the implementation as described above). Power may be supplied via batteries or an external, corded power source.

A C/BW button 306 is provided to toggle between color scanning and black and white scanning. A DPI button 308 is provided to cycle through desired resolutions (e.g. 300, 600, 1200 DPI). A display 310 indicates the settings of the scanner 300, i.e. color versus black and white, scanning resolution, battery life, and number of images that may be stored in the flash memory at the current resolution. The display 310 will also indicate if removable media is inserted in the slot 312, described further below. An operation indicator 314 is provided to prompt the user that the scanner is in a scanning operation. A fault indicator 316 is provided to indicate that the scanning operation has encountered an error, such as out of memory, the user is moving the scanner too quickly or has lifted the scanner from the scanning medium 318.

The scanner 300 may include a slot 312 for removable media, such as SD cards, to increase the available memory on the scanner 300. A USB port 320 is provided to connect the scanner to the handheld computing device 12.

Generally speaking, the document scanner 10, 100, 200, 300 may be battery powered to make it highly mobile. Furthermore, the document scanner 10, 100, 200, 300 is convenient because it does not require a computer to scan images and transfer them to a handheld computing device 12. The document scanner 10, 100, 200, 300 may be very compact, making it further highly portable.

It would be appreciated by those skilled in the art that various changes and modifications can be made to the illustrated embodiments without departing from the spirit of the present invention. All such modifications and changes are intended to be within the scope of the present invention.

What is claimed is:

1. A scanner for a handheld computing device, comprising:
a housing;
a USB port on the housing;
a memory;
a scanning microprocessor configured and arranged to scan and store images on the memory; and
an USB controller configured and arranged to mount the memory as a USB mass storage class device to a handheld computing device connected to the USB port.

2. The scanner of claim 1, further comprising an authentication chip connected to the scanning microprocessor.

3. The scanner of claim 1, further comprising a first button configured and arranged to toggle the scanning microprocessor between a color mode and a black and white mode.

4. The scanner of claim 1, further comprising a second button configured and arranged to cycle the scanning microprocessor through available scanning resolutions.

5. The scanner of claim 4, wherein the second button may be cycled between 300, 600 and 1200 DPI.

6. The scanner of claim 1, further comprising a slot configured and received to receive removable media.

7. The scanner of claim 1, further comprising a RAM buffer configured and arranged to temporarily store images.

8. The scanner of claim 1, wherein the memory is removable.

9. The scanner of claim 1, further comprising a fault indicator providing feedback to the user that the scan is too fast.

10. The scanner of claim 1, further comprising a display configured and arranged to indicate settings of the scanner.

11. The scanner of claim 1, wherein communications with the handheld computing device are through the External Accessory Framework protocol.

12. The scanner of claim 1, further comprising a wand-shaped housing.
